(19) United States
(12) Patent Application Publication
(10) Pub. No.: US 2013/0136462 A1
(43) Pub. Date: May 30, 2013

(54) IMAGE FORMING APPARATUS, CONTROLLING METHOD OF IMAGE FORMING APPARATUS, AND STORAGE MEDIUM

(71) Applicant: CANON KABUSHIKI KAISHA, Tokyo (JP)

(72) Inventor: Toshihiko Iida, Yokohama-shi (JP)

(73) Assignee: CANON KABUSHIKI KAISHA, Tokyo (JP)

(21) Appl. No.: 13/661,715

(22) Filed: Oct. 26, 2012

(30) Foreign Application Priority Data
Nov. 25, 2011 (JP) 2011-256945

(51) Int. Cl. G03G 21/00

(52) U.S. Cl. 399/23

(57) ABSTRACT

Information indicating a paper and information indicating a substitute paper to be used instead of the paper when paper out occurs with the paper are registered such that the information indicating the paper and the information indicating the substitute paper are associated with each other. Thus, when paper out occurs with a certain paper while printing is being performed, then the printing is restarted using the substitute paper registered corresponding to the certain paper.

### BACKGROUND OF THE INVENTION

1. Field of the Invention

The present invention relates to an image forming apparatus, a controlling method of the image forming apparatus, and a storage medium for storing a program to perform the controlling method.

2. Description of the Related Art

Conventionally, in an image forming apparatus, there has been proposed a technique of, in a case where paper out occurs while a print job is being performed, performing printing using another paper.

In Japanese Patent Application Laid-Open No. 2009-256076, paper feeding cassettes are previously grouped and registered. Then, when paper out occurs with a certain cassette, it is controlled to change over the relevant cassette to another one of the grouped cassettes and feed a paper from the changed cassette, thereby preventing the printing from being stopped.

However, in Japanese Patent Application Laid-Open No. 2009-256076, when paper out occurs with a specific kind of paper, it is determined which paper should be used as a substitute paper, depending on how the paper feeding cassettes have been grouped. For this reason, in Japanese Patent Application Laid-Open No. 2009-256076, it is necessary to previously hold the paper that a user wishes to use as the substitute paper in another one of the grouped cassettes.

Further, in Japanese Patent Application Laid-Open No. 2009-256076, even if the paper that the user wishes to use as the substitute paper is held in another one of the grouped cassettes, it is conceivable that another user harmlessly replaces the held paper with another paper afterward. In such a case, although the user believes that the substitute paper is normally used, an unexpected paper is actually used as the substitute paper.

The present invention has been completed in order to solve such a problem as described above, and an object thereof is to provide a mechanism by which it is possible, in a case where paper out occurs with a paper originally used in printing, to determine an appropriate substitute paper.

### SUMMARY OF THE INVENTION

To achieve the above object, according to the present invention, there is provided an image forming apparatus which comprises: a registering unit configured to register paper information which includes characteristic information indicating a characteristic of a paper and substitute paper information indicating a substitute paper to be used instead of the paper in a case where paper out occurs with the paper; a selecting unit configured to select a paper to be used in printing from among the papers registered by the registering unit; a printing unit configured to perform the printing to the paper selected by the selecting unit; and a determining unit configured to, in the case where paper out occurs with the paper selected by the selecting unit while the printing by the printing unit is being performed, determine the substitute paper to be used instead of the paper selected by the selecting unit, based on the substitute paper information corresponding to the paper selected by the selecting unit.

Further features of the present invention will become apparent from the following description of exemplary embodiments with reference to the attached drawings.

### BRIEF DESCRIPTION OF THE DRAWINGS

FIG. 1 is a cross-section diagram for describing a constitution of an image forming apparatus.

FIG. 2 is a block diagram for describing a controlling constitution of the image forming apparatus illustrated in FIG. 1.

FIG. 3 is a block diagram illustrating a module constitution to be controlled by the CPU illustrated in FIG. 2.

FIG. 4 is a flow chart for describing a controlling method of the image forming apparatus.

FIG. 5 is a flow chart for describing the controlling method of the image forming apparatus.

FIG. 6 is a diagram illustrating an example of a UI (user interface) screen to be displayed on the image forming apparatus.

FIG. 7 is a diagram illustrating an example of the UI screen to be displayed on the image forming apparatus.

FIG. 8 is a diagram illustrating an example of the UI screen to be displayed on the image forming apparatus.

FIG. 9 is a diagram illustrating an example of the UI screen to be displayed on the image forming apparatus.

FIG. 10 is a diagram illustrating an example of the UI screen to be displayed on the image forming apparatus.

FIG. 11 is a diagram illustrating an example of the UI screen to be displayed on the image forming apparatus.

FIG. 12 is a flow chart for describing the controlling method of the image forming apparatus.

FIG. 13 is a diagram illustrating an example of the UI screen to be displayed on the image forming apparatus.

### DESCRIPTION OF THE EMBODIMENTS

Hereinafter, embodiments of the present invention will be described with reference to the attached drawings.

<Description of System Constitution>

### First Embodiment

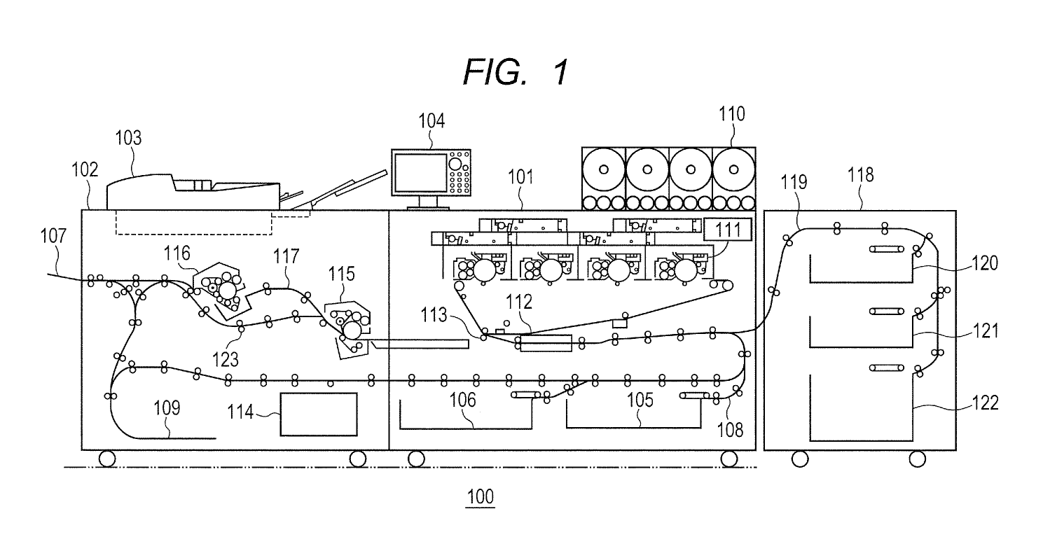

FIG. 1 is a cross-section diagram for describing a constitution of an image forming apparatus according to the first embodiment of the present invention. Incidentally, although the present embodiment is directed to an example of a multifunctional image forming apparatus having a plurality of functions, the present invention is also applicable to a mere printing apparatus having a plurality of paper holding units. Further, the present embodiment is equivalent to an example that the present invention is applied to a printing system corresponding to POD (print on demand). The image forming apparatus in the present embodiment performs image forming while supplying a paper from any one of a plurality of paper holding units (corresponding to later-described cassettes).

In FIG. 1, an image forming apparatus 100 has an image forming unit 101, a fixing unit 102, a scanner unit 103, an operation unit 104, a paper discharging unit 107, a tonner supplying unit 110 and an external paper feeding device 118.

Further, in the image forming unit 101, paper feeding devices 105 and 106 which function as paper holding units (paper feeding cassettes), a conveying unit 108, a primary transfer unit 111, a transfer belt 112 and a secondary transfer unit 113 are provided. In the fixing unit 102, a switchback unit 109, a waste toner holding unit 114, fixing units 115 and 116 and conveying units 117 and 123 are provided. In the external paper feeding device 118, a conveying unit 119 and paper feeding devices 120, 121 and 122 which function as paper holding units (paper decks) are provided.

The scanner unit 103 scans an original and generates electronic data of an image, and that data is temporarily stored in a RAM or the like to be mentioned later. The operation unit 104 receives various instructions to the image forming apparatus 100 instructed by an operator. Further, in the operation unit 104, a display unit such as a touch panel system or the like is provided together with hard keys. Incidentally, various operation screens are displayed on the display unit through a user interface screen (UI screen) to be mentioned later.

The paper feeding devices 105, 106, 120, 121 and 122 stack papers (sheets) used for performing the printing at the image forming apparatus 100. The paper discharging unit 107 discharges a printed paper to an external of the image forming apparatus 100. In the respective conveying units, rollers used for conveying papers are provided at a fixed distance. The switchback unit 109 reverses an output surface of a paper when the paper is discharged to the paper discharging unit 107.

The toner supplying unit 110 supplies respective color toners (toners of respective colors Y, M, C and K) serving as developers to the image forming unit 101. The primary transfer unit 111 transfers a toner image formed in accordance with image data to the transfer belt 112. The secondary transfer unit 113 transfers the toner image, which was transferred to the transfer belt 112, to a paper. The waste toner holding unit 114 stores the extra toner produced in the course of executing a transfer process. The fixing unit 115 applies the heat and pressure to a paper, on which the image was transferred in the secondary transfer unit 113, to fix toner on the paper.

The fixing unit 116 further applies the heat and pressure to the paper on which the image was fixed in the fixing unit 115, and the fixing of the image is intensified. The conveying units 108, 117, 119 and 123 serve as conveying paths used for conveying papers.

The conveying unit 117 serves as a conveying path used for conveying papers from the fixing unit 115 to the fixing unit 116. The conveying unit 123 serves as a conveying path used for conveying papers from the fixing unit 115 to the paper discharging unit 107 or the switchback unit 109 without passing through the fixing unit 116. The conveying units 108 and 119 serve as conveying paths used for feeding papers to the image forming apparatus 100.

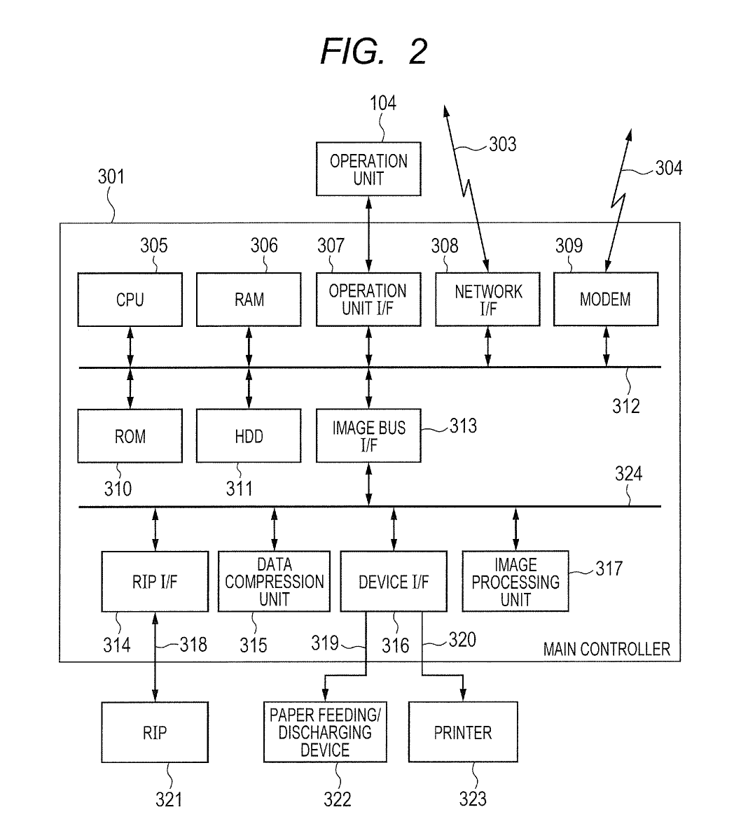

FIG. 2 is a block diagram for describing the control structure of the image forming apparatus 100 indicated in FIG. 1. The present embodiment is directed to an example of the image forming apparatus 100 characterized in that the image forming apparatus itself is controlled by a single-core CPU. However, the present embodiment can be also applied to an image forming apparatus having a multi-core CPU.

In FIG. 2, a main controller 301 has a CPU 305, a RAM 306, an operation unit I/F (interface) 307, a network I/F control unit 308, a MODEM 309, a ROM 310 and an HDD 311 which are connected to a CPU bus 312. In addition, the CPU bus 312 is connected to an image bus 324 through an image bus I/F 313, and the main controller 301 has an RIP (Raster Image Processor) I/F 314, a data compression unit 315, a device I/F 316 and an image processing unit 317 which are connected to the image bus 324. The CPU 305 controls the RAM 306, the operation unit I/F 307, the network I/F control unit 308, the MODEM 309, the ROM 310 and the HDD 311 which are connected to the CPU bus 312. Note that information related to a substitute feeding paper set by a user is registered in the HDD 311. Here, the substitute feeding paper corresponds to a paper to be fed as a substitute paper in a case that a paper-out state occurred when an image formation is performed by feeding a paper selected to an either cassette by a user from paper groups registered in the HDD 311. Further, as for the substitute feeding paper, it is constituted that plural substitute feeding papers can be registered in the HDD 311 by a process that a user sets plural substitute feeding papers for one paper by using an editing screen.

A network cable 303, which is used for connecting with an external device by a network, is connected to the network I/F 308. A line cable 304, which is used for connecting with an external device by a telephone line, is connected to the MODEM 309. The CPU 305 activates a program used for controlling the whole of the main controller 301. The RAM 306 is controlled by a program operating on the CPU 305.

The RAM 306 is used for the purpose of serving as a receiving buffer for temporarily storing data received from the outside or an image data buffer for temporarily storing image data rasterized by an RIP 321. The ROM 310 stores programs or data operating on the CPU 305. The HDD 311 is a nonvolatile storage device which can store various data for a long time.

The operation unit I/F 307 is an interface used for connecting the operation unit 104 with the main controller 301. The image bus I/F 313 is an interface used for connecting the CPU bus 312 with the image bus 324. The RIP 321 is connected to the RIP I/F 314 through a data bus 318. The RIP 321 is a rasterizing board (RIP) which has a function of converting image description data to be input from the outside into bit map image data. The RIP I/F 314 is an interface used for connecting the RIP 321 with the image bus 324 by the data bus 318. The data compression unit 315 compresses data.

A paper feeding/discharging device 322 and a printer 323 are connected to the device I/F 316 respectively through a data bus 319 and a data bus 320. The constitution of the printer 323 is such a constitution as mentioned above with reference to FIG. 1. The CPU 305 issues an instruction for the purpose of performing the printing to the paper feeding/discharging device 322 and the printer 323 respectively through the data bus 319 and the data bus 320 in accordance with a signal instructed from the operation unit 104 or the external device through the network cable 303.

The image processing unit 317 executes various image processes to the bit map image data generated by the RIP 321. The image processing unit 317 has a function of digitally processing the bit map image data such as a function of synthesizing bit map image data of two pages into bit map image data of one page.

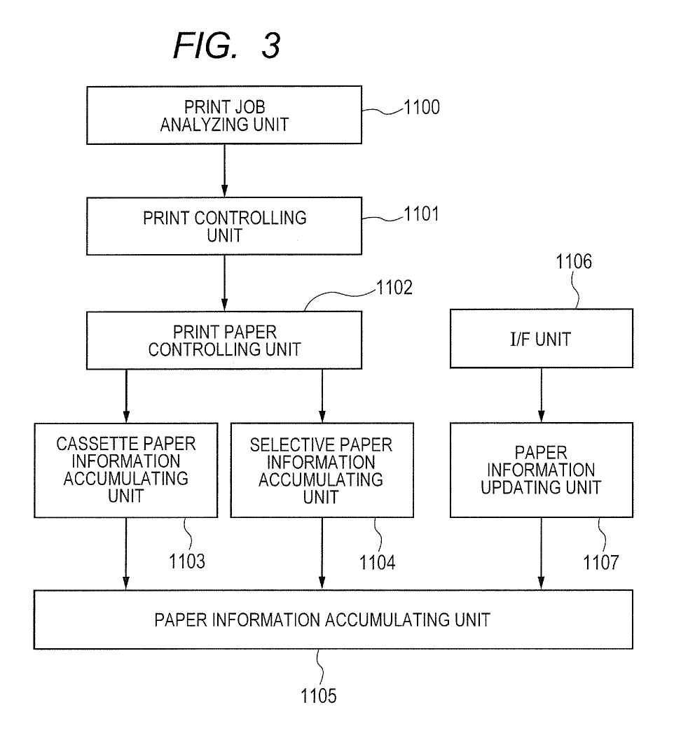

FIG. 3 is a block diagram for describing a module constitution, in which the related processes are executed by the CPU 305 indicated in FIG. 2.

In FIG. 3, a print job analyzing unit 1100 serves as an interpreter for analyzing a job to be performed in the image forming apparatus 100. Here, a description format of a job to be analyzed by the print job analyzing unit 1100 is not designated. A print controlling unit 1101 determines respective parameters necessary for the printing upon receiving an analyzed result of the print job analyzing unit 1100. Here, information related to a paper to be used in the printing is included in the parameters which are determined by the print controlling unit 1101. Note that a selection of the paper to be used in the printing is not limited to such a constitution, where the selection is performed on the basis of a job, but the paper may be selected by a user, for example, through a screen displayed on the operation unit 104.

A print paper controlling unit 1102 controls the feeding of papers actually used in the printing of the job or the feeding of substitute papers on the basis of a flow chart to be mentioned later. Here, the print paper controlling unit 1102, which is controlled by the print controlling unit 1101, determines the paper to be used in the printing from a designated attribute value upon receiving an analyzed result of the job. When the print paper controlling unit 1102 determined the paper to be used in the printing, information of the determined paper is informed to the print controlling unit 1101.

A cassette paper information accumulating unit 1103 accumulates information related to papers which are set in the paper feeding devices 105 and 106 having the paper holding units constituted by the paper feeding cassettes or information related to papers which are set in the paper feeding devices 120 to 122 constituted by the paper decks. When the print paper controlling unit 1102 determined the paper to be used for the printing, it is judged whether or not the papers have been set in the paper feeding devices 105 and 106 or the paper feeding devices 120 to 122 by the information of papers accumulated in the cassette paper information accumulating unit 1103.

In a case that the papers fed from either of the paper feeding devices are used up according to execution of the job, when the print paper controlling unit 1102 checks whether or not the same papers as those used up or the substitute papers of the used-up papers have been set in another paper feeding device or checks whether or not the substitute papers of the used-up papers have been set in either of the paper feeding devices, information in the cassette paper information accumulating unit 1103 is referred.

A selective paper information accumulating unit 1104 accumulates information related to papers which are currently used in the printing with execution of the job. When the print paper controlling unit 1102 determined the papers to be used in the printing with execution of the job, information of the papers determined to be used in the printing is accumulated in the selective paper information accumulating unit 1104. Here, the print paper controlling unit 1102 detects a fact that papers to be fed became a paper-out state in the selected paper feeding device in the course of the printing from information of the center or the like. In this manner, when the print paper controlling unit 1102 detected a fact that the papers became a paper-out state in the course of the printing, the print paper controlling unit 1102 determines papers to be used for the substitute papers with reference to substitute paper information included in the information accumulated in the selective paper information accumulating unit 1104.

All the paper information registered in the image forming apparatus 100 is accumulated in a paper information accumulating unit 1105. Here, information related to the substitute papers to be used when the papers to be fed are used up in either of the paper feeding devices is included in the paper information accumulated in the paper information accumulating unit 1105. As for the paper information accumulated in the paper information accumulating unit 1105, existing paper information can be changed or paper information can be newly registered from an I/F unit 1106 through a paper information updating unit 1107.

The I/F unit 1106 serves as a user interface such as input keys, a touch panel or the like, and a user can display registration paper information and can input updating information through the I/F unit 1106.

The paper information updating unit 1107 updates the paper information accumulated in the paper information accumulating unit 1105 on the basis of the updating information of the registration paper which was input through the I/F unit 1106.

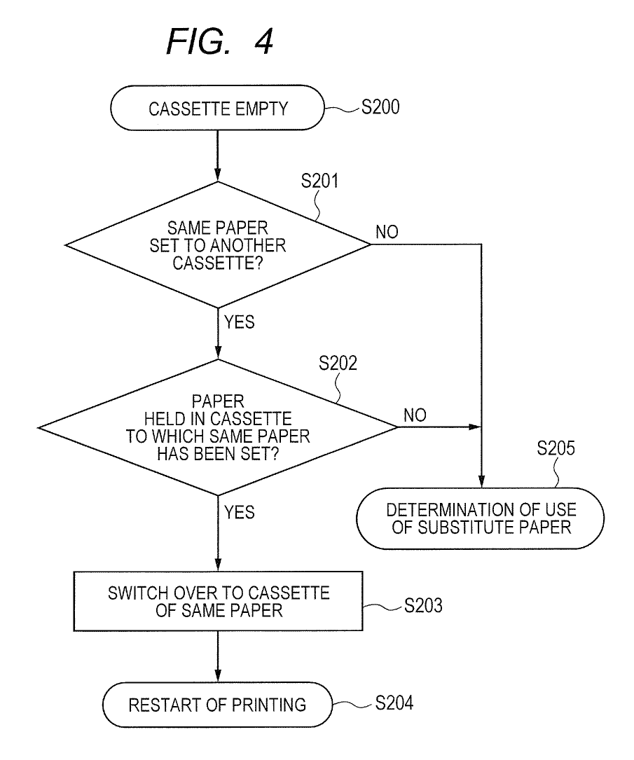

FIG. 4 is a flow chart for describing a control method of the image forming apparatus indicating the present embodiment. This method corresponds to a flow until determining whether a substitute paper is used when a paper used for the printing was used up. Note that each step is realized by a process that the CPU 305 executes a control program stored in the ROM 310 and the HDD 311 by loading the control program into the RAM 306. Here, procedures in a module indicated in FIG. 3 are included in the control program. In the following description, a control procedure will be described by treating the module indicated in FIG. 3 as a main constituent. Here, as the paper feeding devices, the paper feeding devices 105 and 106 (each of them corresponds to a paper feeding cassette) and the paper feeding devices 120 to 122 (each of them corresponds to a paper deck) are provided. Therefore, in the following description, in a case that both devices are not distinguished, they are merely described as cassettes.

In a step S200, when the print paper controlling unit 1102 judged that a state of the paper feeding device, in which papers are currently used, changed to an empty state (a paper-out state) while the printer 323 is executing a job by detecting this fact from an output of a paper existence sensor (not illustrate), the flow shifts to a step S201.

Then, in the step S201, the print paper controlling unit 1102 compares information accumulated in the cassette paper information accumulating unit 1103 with information accumulated in the selective paper information accumulating unit 1104 and discriminates whether or not the same paper as that of used for the printing has been set to another cassette. Here, when the print paper controlling unit 1102 discriminated that the same paper was set to another cassette, it is judged whether or not the paper is held in that cassette (step S202). According to results in the steps S201 and 5202, when it was judged that there was a cassette, to which the same paper as that used up in the course of the printing has been set, and the paper was held in that cassette, the flow advances to a step S203. Then, in the step S203, the print paper controlling unit 1102 switches a cassette, which has to feed papers, to a cassette, to which the same paper as that of mentioned in the above has been set, capable of feeding papers, then in a step S204, the printing of a job is restarted by starting to feed papers from the switched cassette.

On the other hand, when the print paper controlling unit 1102 judged that the same paper as that used up in the course of the printing has not been set to another cassette in the step S201, the flow advances to a step S205. Similarly, when the print paper controlling unit 1102 judged that although there was a cassette to which the same paper has been set, the paper was not held in that cassette in the step S202, the flow advances to the step S205.

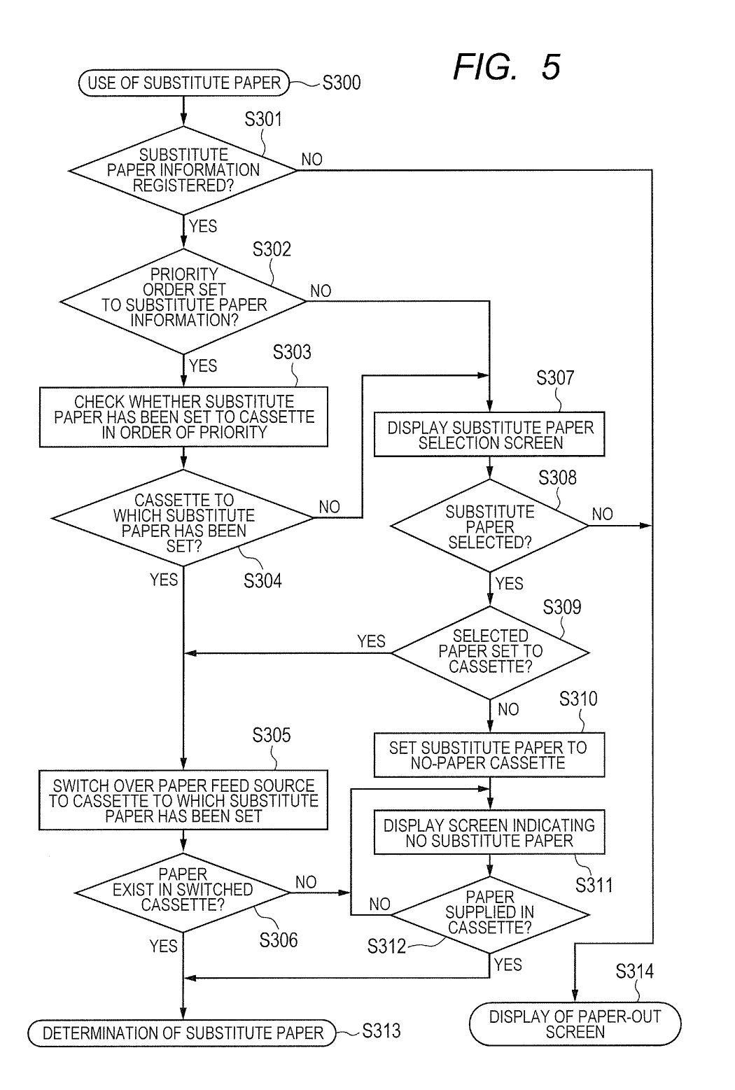

Then, in the step S205, the print paper controlling unit 1102 executes a process of determining the substitute paper indicated in detail in FIG. 5.

FIG. 5 is a flow chart for describing a control method of the image forming apparatus indicating the present embodiment. This method corresponds to a detailed procedure of a process of determining the substitute paper in the step S205 indicated in FIG. 4. Note that each step is realized by a process that the CPU 305 executes a control program stored in the ROM 310 and the HDD 311 by loading the control program into the RAM 306. Here, procedures in a module indicated in FIG. 3 are included in the control program. In the following description, a control procedure will be described by treating the module indicated in FIG. 3 as a main constituent.

First, after the print paper controlling unit 1102 determined to use the substitute paper in a step S300, the print paper controlling unit 1102 refers paper information of the paper which firstly became a paper-out state and judges whether or not substitute paper information is registered in the paper information accumulating unit 1105 in a step S301. Here, when the print paper controlling unit 1102 judged that the substitute paper information was not registered, the flow advances to a step S314, and a paper-out screen of the paper (i.e., a screen indicating no paper), which became a paper-out state, is displayed on the operation unit 104. Here, a user can restart the printing by supplying (adding) papers to the paper feeding device or can select to cancel a job in the course of the printing from a screen to be displayed on the operation unit 104.

On the other hand, in the step S301, when the print paper controlling unit 1102 judged that the substitute paper information is registered in the paper information accumulating unit 1105, the print paper controlling unit 1102 further judges whether or not the priority order to use is set to the substitute paper in a step S302. Note that the step S302 is not always required in the present process, and the priority order is allowed not to exist as an explicit setting item. For example, a paper registered as the substitute paper 1 is treated as the paper of the highest priority order, and a setting item called as priority order may be omitted.

In the step S302, the print paper controlling unit 1102 judges whether or not priority order information is set to the substitute paper information. Here, when the print paper controlling unit 1102 judged that the priority order was set without inquiring explicit or implicit, the flow advances to a step S303. Then, the print paper controlling unit 1102 checks whether the substitute paper has been set to either cassette (a paper feeding cassette or a paper deck) in the order of the set priority (step S303).

Then, the print paper controlling unit 1102 judges whether or not the substitute paper has been set to either cassette (step S304). Here, when the print paper controlling unit 1102 judged that the substitute paper was set to either cassette, the print paper controlling unit 1102 switches a cassette, to which the substitute paper has been set, to a cassette of the paper feed source, in a step S305. Then, in a step S306, the print paper controlling unit 1102 judges whether or not the paper exists in the switched cassette. Here, when the print paper controlling unit 1102 judged that the paper was set in the switched cassette, the flow advances to a step S313, and the print paper controlling unit 1102 determines the paper held in the switched cassette as the substitute paper.

On the other hand, in the step S302, when the print paper controlling unit 1102 judged that the priority order information has not been set to the substitute paper, or in the step S304, when the print paper controlling unit 1102 judged that a cassette set in the substitute paper information did not exist, the flow advances to a step S307.

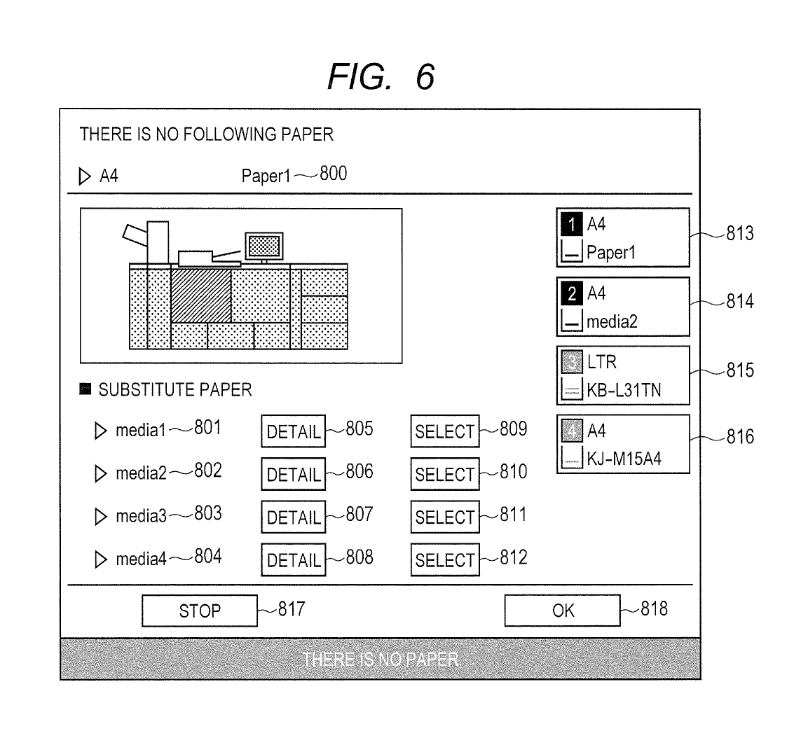

Then, in the step S307, the print paper controlling unit 1102 displays a user interface screen indicated in FIG. 6 on the operation unit 104 in order that a user manually sets the substitute paper.

FIG. 6 is a diagram indicating an example of the user interface screen to be displayed at the image forming apparatus indicating the present embodiment. This screen corresponds to the UI screen used for a purpose that the user manually selects the substitute paper.

The user confirms a substitute paper selection screen indicated in FIG. 6 to be displayed on the operation unit 104 and selects whether the user uses the registered substitute paper or performs the printing by adding a paper which became a paper-out state or stops the printing. Note that the constitution of the substitute paper selection screen and respective buttons indicated in FIG. 6 will be described later. If the substitute paper is used, it is assumed that an impression of a printed paper will be changed according to the kind of substitute paper. That is, there is also a case that the printing should be stopped without using the substitute paper, for example, a case that quality of the printed paper on a POD (Print On Demand) market is regarded as an important matter, and the user can select whether or not the printing is stopped by the substitute paper selection screen indicated in FIG. 6.

Next, in a step S308, the print paper controlling unit 1102 judges whether or not the user selects the registered substitute paper after confirming the substitute paper selection screen indicated in FIG. 6 to be displayed on the operation screen 104. Here, when the print paper controlling unit 1102 judged that the user did not select the substitute paper, the flow advances to a step S314, and a paper-out screen is displayed on the operation unit 104.

On the other hand, in the step S308, when the print paper controlling unit 1102 judged that the user selected the substitute paper, the print paper controlling unit 1102 judges whether or not the substitute paper selected by the user has been set to either cassette by the UI screen indicated in FIG. 6 in a step S309.

Here, when the print paper controlling unit 1102 judged that the substitute paper selected by the user has been set to the cassette, a flow shifts to the step S305, and the print paper controlling unit 1102 switches over a cassette, to which the selected substitute paper has been set, to a paper feed source.

On the other hand, in the step S309, when the print paper controlling unit 1102 judged that the substitute paper selected by the user has not been set to the cassette, the flow advances to a step S310. Then, in the step S310, the substitute paper is set to a cassette which became a paper-out state. Since the paper is not held in this cassette, the print paper controlling unit 1102 displays a UI screen, which is used to be confirmed by the user that the substitute paper is in a paper-out state, on the operation unit 104 in a step S311 after setting the substitute paper.

Next, in a step S312, the print paper controlling unit 1102 judges whether or not the substitute paper is added to the cassette by supplying the substitute paper. Here, when the print paper controlling unit 1102 judged that the paper has been supplied to the cassette, a flow shifts to the step S313, and the paper supplied to the cassette is determined as the substitute paper.

On the other hand, in the step S312, when the print paper controlling unit 1102 judged that the paper has not been supplied to the cassette, the steps S311 and S312 are repeated until the substitute paper set by the user is supplied to the cassette, and the substitute paper is not determined.

Incidentally, in the step S311, it may be constituted that cancellation of a job can be selected on the basis of a selection operation of the user from the paper-out screen to be displayed on the operation unit 104.

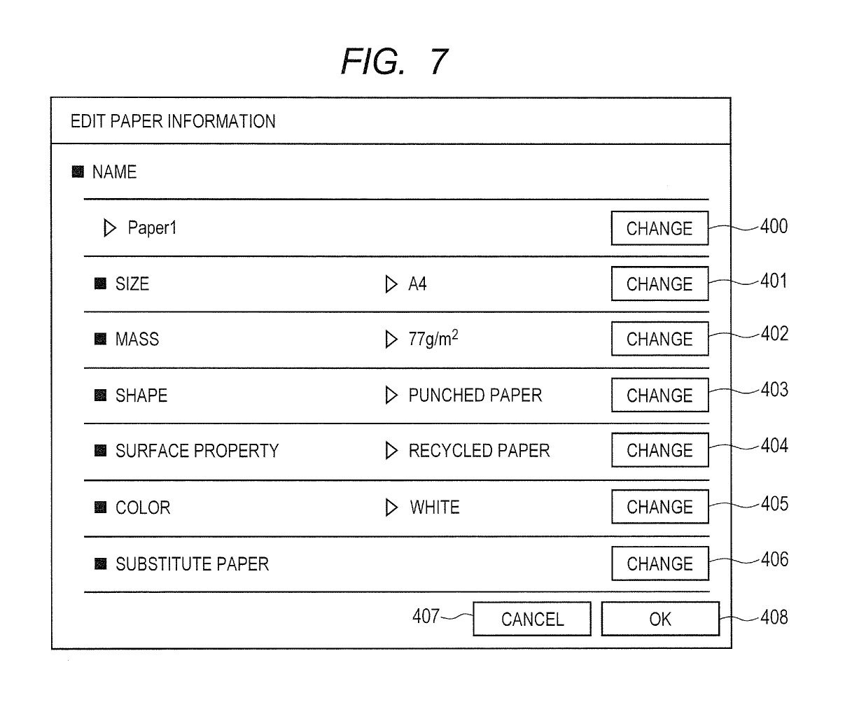

FIGS. 7 to 10 are diagrams for indicating an example of a user interface screen to be displayed at the image forming apparatus indicating the present embodiment. This screen corresponds to a screen used for registering paper information by editing the paper information by the user. In the present embodiment, it is constituted that plural substitute papers can be registered for one paper, further, it is constituted that the priority order intended by the user can be registered or the priority order is automatically added and can be registered in the HDD 311 for the plural substitute papers.

In FIG. 7, a change button 400 is depressed in case of changing a name of paper. A change button 401 is depressed in case of changing a paper size. A change button 402 is depressed in case of changing the mass of paper. It is constituted that the mass can be set with a unit of g/m².

A change button 403 is depressed in case of changing the shape of paper. As the shape of paper, for example, a normal paper, a punched paper or the like can be set. A change button 404 is depressed in case of changing a surface property of paper. As the surface property of paper, for example, a plain paper, a recycled paper or the like can be set. A change button 405 is depressed in case of changing color of paper. As the color of paper, for example, white, yellow or the like can be set. These characteristics such as the mass of paper, the shape of paper, the surface property of paper and the color of paper are registered in the image forming apparatus 100 as characteristic information indicating the characteristic of paper.

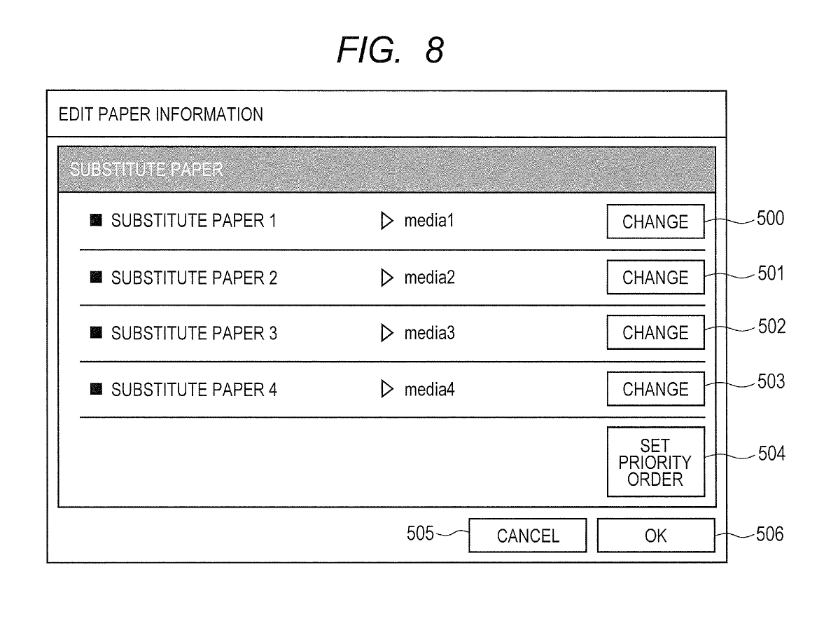

A change button 406 is depressed in case of changing a substitute paper. Incidentally, when the change button 406 is depressed, a display screen of the operation unit 104 is switched from a display screen indicated in FIG. 7 to a display screen indicated in FIG. 8. A cancel button 407 is depressed in case of deleting the display screen indicated in FIG. 7. An OK button 408 is depressed in case of determining the screen contents indicated in FIG. 7.

In FIG. 8, a change button 500 is depressed in case of changing a substitute paper 1. A change button 501 is depressed in case of changing a substitute paper 2. A change button 502 is depressed in case of changing a substitute paper 3. A change button 503 is depressed in case of changing a substitute paper 4.

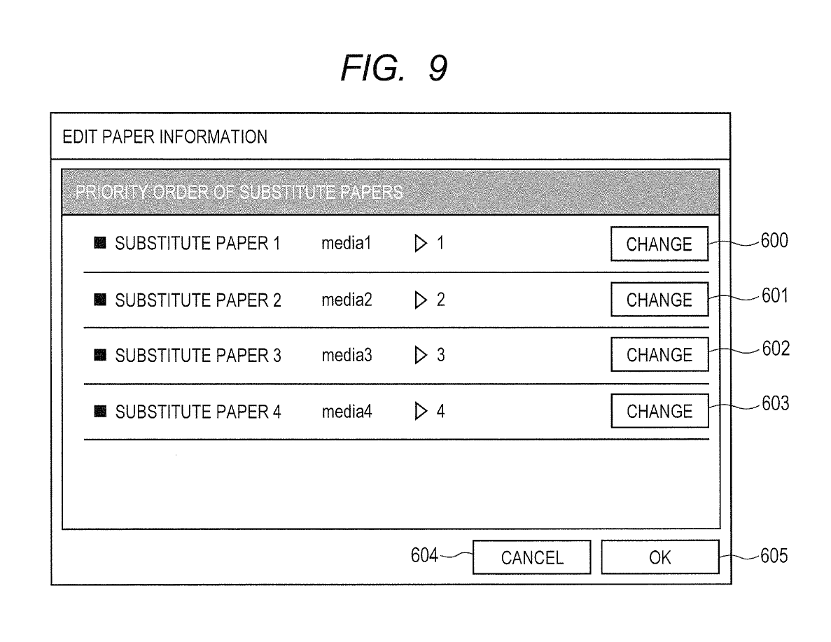

A button 504 is a priority order setting button, and when this button is depressed, the display screen of the operation unit 104 is switched from the display screen indicated in FIG. 8 to a display screen indicated in FIG. 9.

A cancel button 505 is depressed in case of deleting the display screen indicated in FIG. 8. An OK button 506 is depressed in case of determining the screen contents indicated in FIG. 8.

In FIG. 9, a change button 600 is depressed in case of changing the priority order of the substitute paper 1. A change button 601 is depressed in case of changing the priority order of the substitute paper 2. A change button 602 is depressed in case of changing the priority order of the substitute paper 3. A change button 603 is depressed in case of changing the priority order of the substitute paper 4.

A cancel button 604 is depressed in case of deleting the display screen indicated in FIG. 9. An OK button 605 is depressed in case of determining the screen contents indicated in FIG. 9.

Hereinafter, an editing process of paper information including substitute paper information will be described with reference to user interface screens indicated in FIG. 7 and the like.

In the present embodiment, as for the registration and change of the substitute paper, it can be shifted to an editing screen by an operation that a user depresses the change button 406 indicated in FIG. 7 displayed on the operation unit 104. The editing screen of paper information is terminated by depressing the OK button 408 after changing arbitrary paper information. Further, the change can be canceled by depressing the cancel button 407.

Then, in a display screen of the operation unit 104, the display screen is switched to the display screen indicated in FIG. 8 by an operation that a user depresses the change button 406. In the present embodiment, although the substitute papers can be registered up to four kinds of papers, the number of them is not limited.

In the screen indicated in FIG. 8, when a user depresses the change buttons 500 to 503, the print paper controlling unit 1102 switches the display screen to a screen used for registering the substitute paper. Here, when the user depresses the priority order setting button 504, the print paper controlling unit 1102 displays a screen indicated in FIG. 9 used for determining the priority order of using the substitute paper.

Here, it is allowed that the user does not set the priority order in the screen indicated in FIG. 9, and the substitute paper 1 is allowed to be regarded as the paper of the highest priority order and the substitute paper 4 is allowed to be regarded as the paper of the lowest priority order.

In this manner, when completing the registration of the substitute paper, a substitute paper registration screen is terminated by depressing the OK button 506 indicated in FIG. 8, and a screen is switched from the display screen indicated in FIG. 9 to the display screen indicated in FIG. 7. In the screen indicated in FIG. 8, the change of the substitute paper can be also canceled by an operation that the user depresses the cancel button 505.

FIG. 9 indicates a user interface screen, which is to be switched to this screen when the user depressed the priority order setting button 504 in a user interface screen indicated in FIG. 8 and corresponds to a screen used for setting the priority order of using the registered substitute paper.

The setting of the priority order is performed by depressing the change buttons 600 to 603 indicated in FIG. 9. A value set here is held in the HDD 311 to be referred when automatically determining the substitute paper to be used in the step S303 indicated in FIG. 5. In this manner, when the setting of the priority order is completed, a display of the substitute paper registration screen indicated in FIG. 9 is terminated by an operation that the user depresses the OK button 605 to be returned to the user interface screen indicated in FIG. 8.

In the user interface screen indicated in FIG. 9, the change of the substitute paper can be canceled by an operation that the user depresses the cancel button 604 indicated in FIG. 9.

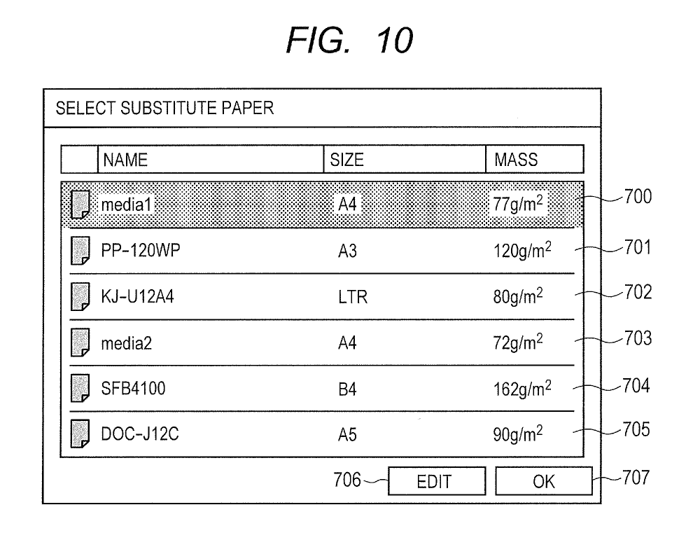

A user interface screen indicated in FIG. 10 is an example of a screen, which is to be shifted to this screen by an operation that the user depresses the change buttons 500 to 503 in the user interface screen indicated in FIG. 8 and is used for registering the substitute paper to be registered.

In FIG. 10, paper information 700 to 705 correspond to a part of paper information registered in the image forming apparatus, and a displayed state in case of selecting paper information (media 1) of the current paper information 700 is indicated. When the user depresses an OK button 707 in this displayed state, the paper information 700 can be registered in the substitute paper information. And, a screen is switched to an editing screen used for editing paper information of the paper which is currently selected by an operation that the user depresses an editing button 706.

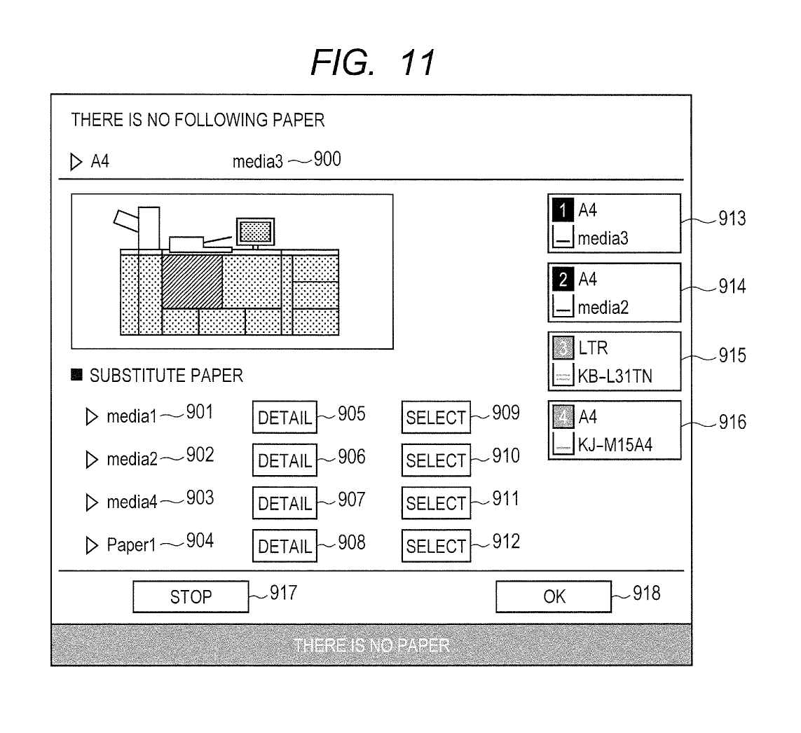

Hereinafter, a selection screen display operation of the substitute paper to be displayed in the step S307 indicated in FIG. 5 will be described with reference to FIGS. 6 and 11.

In FIG. 6, a paper-out displaying section 800 indicates a fact that A4 size papers of which a paper name is Paper 1 became a paper-out state. Papers displayed at sections of registered substitute papers 801 to 804 correspond to papers which were registered as the substitute papers. Here, the registered substitute papers 801 to 804 denote a substitute paper group registered for the paper name (Paper 1) which became a paper-out display state. Here, detailed paper information can be referred on the operation unit 104 by an operation that the user selects and depresses detailed information buttons 805 to 808. Paper information set to respective cassettes is displayed at paper buttons 813 to 816.

The user selects the substitute paper to be used by an operation that the user depresses selection buttons 809 to 812 or the paper button 814 which corresponds to the paper in a cassette (cassette 2), to which the paper registered as the substitute paper is set, for example, a cassette in which media 2 registered as the substitute paper are held. Specifically, when the user selected the paper held in the cassette 2 at the present moment, for example, “media 2” of the paper button 802, processes in the steps from S307 to S309 are executed, and a flow shifts to the step S305.

When the user selected the paper not held in the cassette at the present moment, that is, selected media 1, media 3 and media 4 in the present embodiment, processes in the steps from S307 to S309 are executed, and a flow shifts to the step S310. In the step S310, the substitute paper selected by the paper button 813 indicated in FIG. 6 is set, and a flow shifts to the step S311. An example of a screen to be displayed in the step S311 will be indicated in FIG. 11.

In the user interface screen indicated in FIG. 6, when the user depresses a stop button 817, a job in the middle of the printing can be canceled. Further, in the user interface screen indicated in FIG. 6, when the user depresses an OK button 818, the user interface screen indicated in FIG. 6 can be closed. In this case, a paper-out state is kept.

FIG. 11 indicates an example of a user interface screen to be displayed on the operation unit 104 in the step S311 indicated in FIG. 5. In the present embodiment, this user interface screen corresponds to a display screen when the selection button 811 is depressed in a paper-out screen of the substitute paper to be displayed in the step S311 indicated in FIG. 5.

In FIG. 11, buttons 913 to 916 are paper buttons. Note that buttons 905 to 912 are similar to the buttons 805 to 812, 817 and 819 indicated in FIG. 6.

In this screen, the selected media 3 is displayed at a paper-out displaying section 900, and the media 3 has been set to the cassette 1 which became a paper-out state. The substitute papers registered in the media 3 are displayed at sections of registered substitute papers 901 to 904. When the substitute paper which is not registered in this screen is selected (when any of selection buttons 909, 911 and 912 is depressed), a paper-out screen of the substitute paper is displayed by the reselected paper.

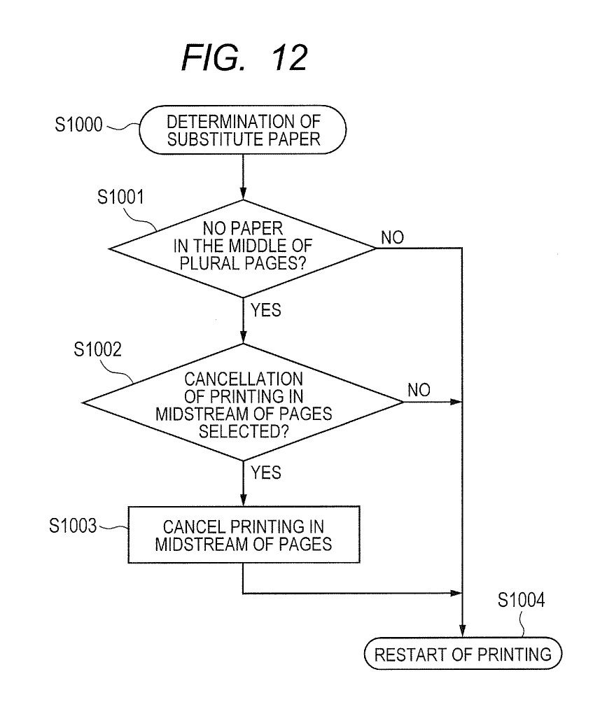

FIG. 12 is a flow chart for describing a control method of the image forming apparatus indicating the present embodiment. This method corresponds to a flow of process until the printing is restarted by using the substitute paper after the substitute paper was determined.

Note that each step is realized by a process that the CPU 305 executes a control program stored in the ROM 310 and the HDD 311 by loading the control program into the RAM 306. Here, procedures in a module indicated in FIG. 3 are included in the control program. In the following description, a control procedure will be described by treating the module indicated in FIG. 3 as a main constituent.

In a step S1000, when the print paper controlling unit 1102 determined the substitute paper in accordance with the above-mentioned process, the print paper controlling unit 1102 judges whether or not a paper-out state occurred in the middle of the printing of a printed matter having plural pages in a step S1001. Here, when the print paper controlling unit 1102 judged that the paper-out state did not occur in the middle of the printing of one printed matter, the flow advances to a step S1004, and the printing is restarted as it is.

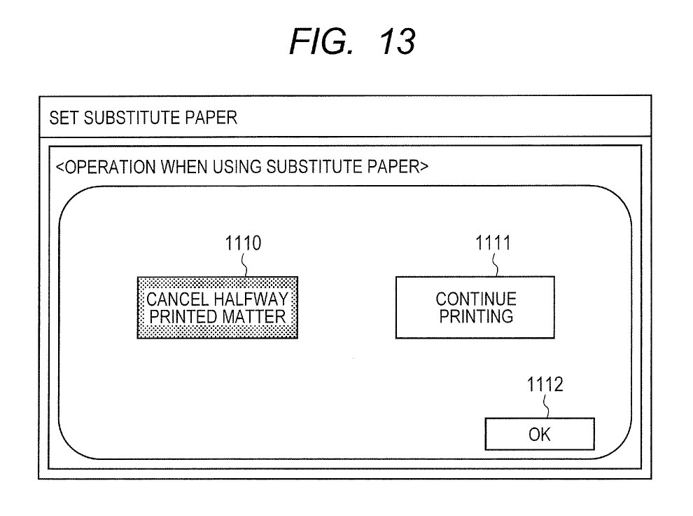

On the other hand, when the print paper controlling unit 1102 judged that the paper-out state occurred in the middle of the printing of the one printed matter in the step S1001, a flow shifts to a step S1002. Then, in the step S1002, the print paper controlling unit 1102 judges whether or not the user is selecting to cancel the printing of that printed matter by using the UI screen indicated in FIG. 13 in case of using the substitute paper in the middle of the printing of the printed matter. Incidentally, instead of a judgment step of selection, a step of judging whether or not a stop button 917 functions as a button of canceling the printing of the printed matter is depressed in a user interface screen indicated in FIG. 11 is allowed in the present step.

On the other hand, in the step S1002, when the print controlling unit 1102 judged that it has been set to cancel the printing of the printed matter, which is in the middle of the printing, when using the substitute paper, a flow shifts to a step S1003, and the printing of the printed matter which is in the middle of the printing is canceled. Then, after the cancellation, the print paper controlling unit 1102 performs to shift a flow to the step S1004, and the printing is restarted from a first page of that printed matter.

On the other hand, in the step S1002, when the print paper controlling unit 1102 judged that it has been set to continue the printing as it is, a flow shifts to the step S1004, and the printing is restarted without canceling the printing of the printed matter.

FIG. 13 is a diagram indicating an example of a user interface screen to be displayed at the image forming apparatus indicating the present embodiment. This screen corresponds to an acceptance screen used for accepting a request of the restart of continuing the printing as it is or a request of the print stop whether the printing is performed from a first page by canceling the printing of the printed matter in case of using the substitute paper in the middle of the printing of the printed matter. In a case that the printing was restarted by using the substitute paper when a paper-out state occurred at the page in the middle of a print job, since the kind of paper to be used is changed before and after the restart of the printing, there is the possibility of changing impression of the printed matter before and after the restart of the printing. Therefore, an operation whether the substitute papers are used from the page in the middle of pages or whether the printing is restarted from a first page is made to be selected by the user by displaying a screen indicated in FIG. 13. As for this setting, it is desirable that the user can arbitrary perform the setting, and the user is urged to select either button from a button 1110 used for canceling the printing of the printed matter in the middle of the printing and a button 1111 used for continuing the printing as it is in the step S1002 by displaying a screen indicated in FIG. 13 on the operation unit 14. Here, the flow advances to the step S1003 indicated in FIG. 12 by a process that the user depresses a button 1112, and the printing of the printed matter in the middle of the printing can be canceled.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-256945, filed Nov. 25, 2011, which is hereby incorporated by reference herein in its entirety.

What is claimed is:

1. An image forming apparatus comprising:
a registering unit configured to register paper information which includes characteristic information indicating a characteristic of a paper and substitute paper information indicating a substitute paper to be used instead of the paper in a case where paper out occurs with the paper;
a selecting unit configured to select a paper to be used in printing from among the papers registered by the registering unit;
a printing unit configured to perform the printing to the paper selected by the selecting unit; and
a determining unit configured to, in the case where paper out occurs with the paper selected by the selecting unit while the printing by the printing unit is being performed, determine the substitute paper to be used instead of the paper selected by the selecting unit, based on the substitute paper information corresponding to the paper selected by the selecting unit.

2. The image forming apparatus according to claim 1, further comprising a controlling unit configured to control the printing unit to restart the printing using the substitute paper determined by the determining unit.

3. The image forming apparatus according to claim 2, wherein the controlling unit controls, in a case where the printing unit performs the printing of a plurality of pages, the printing unit to restart the printing from the page on which the paper out occurred.

4. The image forming apparatus according to claim 2, wherein the controlling unit controls, in a case where the printing unit performs the printing of a plurality of pages, the printing unit to restart the printing not from the page on which the paper out occurred but from a first page.

5. The image forming apparatus according to claim 2, wherein the controlling unit determines, in a case where the printing unit performs the printing of a plurality of pages, whether to restart the printing from the page on which the paper out occurred or to restart the printing not from the page on which the paper out occurred but from the first page, based on an instruction by a user.

6. The image forming apparatus according to claim 1, wherein
the registering unit can register a plurality of substitute paper information, and
the determining unit selects the substitute paper to be actually used from among the plurality of substitute papers.

7. The image forming apparatus according to claim 6, wherein the determining unit determines and selects the substitute paper to be actually used from among the plurality of substitute papers, based on a predetermined priority order.

8. The image forming apparatus according to claim 7, wherein the predetermined priority order is registered by the registering unit such that the predetermined priority order is associated with the plurality of substitute papers.

9. The image forming apparatus according to claim 1, wherein the characteristic information indicates a size of the paper, mass of the paper, a shape of the paper, a surface property of the paper, and a color of the paper.

10. A controlling method of an image forming apparatus, comprising:
registering paper information which includes characteristic information indicating a characteristic of a paper and substitute paper information indicating a substitute paper to be used instead of the paper in a case where paper out occurs with the paper;
selecting a paper to be used in printing from among the registered papers; and
in the case where paper out occurs with the selected paper while printing using the selected paper is being performed, determining the substitute paper to be used instead of the selected paper, based on the substitute paper information corresponding to the selected paper.

11. A non-transitory computer-readable storage medium for storing a program to cause the controlling method of the image forming apparatus according to claim 10.
